(19) United States
(12) Patent Application Publication
(10) Pub. No.: US 2003/0062122 A1
(43) Pub. Date: Apr. 3, 2003

(54) Optical fiber processing system and method

(76) Inventors: Richard J. Keane, Melrose, MA (US); Harold G. Watts JR., Holden, MA (US); Jon H. Appleby, Boston, MA (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/969,544

(22) Filed: Oct. 2, 2001

(51) Int. Cl. B32B 31/20

(52) U.S. Cl. 156/308.2

(57) ABSTRACT

A method and apparatus for processing of optical fibers, including optical fibers that are part of an optical device. In one illustrative embodiment, one or more optical fibers may be secured to a work pallet that is moved within a processing system before, during and/or after processing of the fibers. Optical fibers may be picked from the work pallet and processed while a portion of the fibers remains secured to the work pallet. Two or more processes may be performed on a fiber for each pick of the fiber from the work pallet. Optical fibers may be handled by gripping devices that include one curved clamping surface and two planar surfaces. Gripping devices may operate in open, closed and contain states when handling optical fibers.

### BACKGROUND OF THE INVENTION

1. Field of Invention

This invention relates to processing optical fibers.

2. Description of Related Art

Optical components, such as couplers, switches, multiplexers, sensors, waveguides and others, are widely used in optical-based telecommunications and other systems. Often, such optical components are integrated into a single optical device that can be added in a modular fashion to a telecommunications or other system. As an example, an optical device may include one or more components, such as a photosensor and an optical amplifier, that are interconnected with each other by one or more fiber optic connections and function as an integrated unit.

When fabricating modular optical devices, manufacturers may assemble separate optical components on a same circuit board or other carrier. Fiber optic leads from each of the components may be interconnected using standard splicing techniques as is well-known in the art. The fabrication of optical devices typically involves much manual handling of the components and optical fibers, particularly in splicing optical fibers for the optical components.

### SUMMARY OF THE INVENTION

The inventors have found that automated processing with respect to the construction of optical devices, including apparatus to perform such automated processing, is nearly nonexistent, and in those cases where some automated processing is performed, human intervention is frequently required. Presumably, the lack of automation found in processing optical devices is due to the inability of others to solve problems necessary to automate the processing of optical devices. Various aspects of the invention solve such problems and allow for efficient automated processing of optical devices.

In one illustrative embodiment in accordance with the invention, an optical fiber processing apparatus includes a first optical fiber processing station arranged to process at least one optical fiber associated with a work pallet. The at least one optical fiber may have a fixed portion fixed to the work pallet and a free end opposite the fixed portion that is movable relative to the work pallet. At least one manipulator is constructed and arranged to pick the free end of the at least one optical fiber from the work pallet, deliver the free end of the at least one optical fiber to the first optical fiber processing station, and return the free end to the work pallet after processing by the first optical fiber processing station is complete.

In another illustrative embodiment, the optical fiber processing apparatus may include a transport adapted to move the work pallet relative to the optical fiber processing station. For example, the transport may move the work pallet while the free end of one or more optical fibers is removed from the work pallet for processing.

In another illustrative embodiment, one or more optical fiber processing stations may be positioned above the work pallet while processing one or more optical fibers secured to a work pallet. Processing by the optical fiber processing stations may be simultaneous or nearly simultaneous.

In another illustrative embodiment, the optical fiber processing apparatus may include two optical fiber processing stations and at least one optical fiber may be picked from the work pallet and processed by two or more processing stations before being returned to the work pallet. In another illustrative embodiment, two or more optical fibers from a work pallet may be approximately simultaneously processed by two or more optical fiber processing stations.

In another aspect of the invention, a manipulation apparatus for handling optical fibers includes a first clamping surface including a curved surface and a second clamping surface including two planar surfaces arranged at an angle with respect to each other. The first and second clamping surfaces may be moved toward each other to capture an optical fiber between at least a portion of the curved surface of the first clamping surface and at least a portion of each of the two planar surfaces of the second clamping surface.

In another aspect of the invention, a clamping force exerted on an optical fiber by a gripping device may be determined based on an air pressure. For example, a pneumatic cylinder may be used to move two or more clamping surfaces together to grip an optical fiber, and the air pressure supplied to the pneumatic cylinder may define the clamping pressure exerted on the fiber.

In another aspect of the invention, a gripping device for handling optical fibers may be operable in three states: an open state in which an optical fiber is not held between clamping surfaces in the gripping device, a closed state in which an optical fiber is securely clamped between the clamping surfaces, and a contain state in which an optical fiber is restrained within an area near the clamping surfaces, but not securely clamped between the clamping surfaces.

In another aspect of the invention, a manipulation apparatus for handling optical fibers may include two gripping devices that are movable relative to each other along an axial direction approximately parallel to a longitudinal axis of an optical fiber held by the gripping devices. Such axial movement of the gripping devices may tension an optical fiber held between the gripping devices.

In another aspect of the invention, an optical fiber held by a first manipulator may be handed off or otherwise transferred to a second manipulator. For example, first and second gripping devices in the first manipulator may hold an optical fiber while third and fourth gripping devices in a second manipulator move near the first and second gripping devices and grasp the optical fiber. Once the optical fiber is grasped by the third and fourth gripping devices, the first and second gripping devices may release the optical fiber.

Methods for processing at least one optical fiber in accordance with the invention are also provided. In one illustrative embodiment, at least one optical fiber associated with a work pallet is processed. The at least one optical fiber may have a fixed portion fixed to the work pallet and a free end opposite the fixed portion that is movable relative to the work pallet. According to one illustrative method, the free end of at least one optical fiber is picked from the work pallet via a manipulator apparatus, and delivered to a first optical fiber processing station. The free end is returned to the work pallet after processing by the first optical fiber processing station is complete.

In one illustrative embodiment, the free end of the at least one optical fiber may be grasped with gripping devices at two displaced positions along a length of the at least one optical fiber.

In another illustrative embodiment, a free end of at least one other optical fiber may be picked from the work pallet, and delivered to a second processing station. At least one process may be performed on the free end of the at least one optical fiber at the first optical fiber processing station approximately simultaneously with at least one process performed on the free end of the at least one other optical fiber at a second optical fiber processing station.

In another illustrative embodiment, at least one process may be performed on the free end of the at least one optical fiber at the first optical fiber processing station, and the free end delivered to a second optical fiber processing station without returning the free end of the at least one optical fiber to the work pallet. Delivery of the free end may involve a transfer of the optical fiber from a first manipulator to a second manipulator, e.g., in a handoff operation.

In another illustrative embodiment, the work pallet may be moved during a time in which the free end of the at least one optical fiber is removed from the work pallet for processing or other purposes.

In another illustrative embodiment, the free end of an optical fiber may be delivered to the first optical fiber processing station at a position above the work pallet.

### BRIEF DESCRIPTION OF THE DRAWINGS

Various aspects of the invention will be appreciated more fully with reference to the following detailed description of illustrative embodiments in conjunction with the following drawings, wherein like reference characters denote like elements, and:

FIG. 1 is a schematic diagram of an illustrative embodiment of an optical fiber processing system in accordance with the invention;

FIG. 2 is a schematic diagram showing ranges of motion for manipulators in the FIG. 1 system;

FIG. 3 is a schematic diagram of an illustrative work pallet for use with the FIG. 1 embodiment;

FIG. 4 is a perspective view of one illustrative embodiment of a portion of the first manipulator in the FIG. 1 embodiment;

FIG. 5 is a perspective view of one illustrative embodiment of a second manipulator for use with the FIG. 1 embodiment;

FIG. 6 is a perspective view of one illustrative embodiment of a third manipulator for use with the FIG. 1 embodiment;

FIG. 7 shows an illustrative arrangement of the first, second and third manipulators of FIGS. 4-6;

FIG. 8 shows an illustrative embodiment of an optical fiber gripping device in accordance with the invention;

FIG. 9 shows a close-up view of the jaws in the FIG. 8 gripping device;

FIG. 10 shows the gripping device of FIG. 8 in a closed state;

FIG. 11 shows the gripping device of FIG. 8 in a contain state;

FIG. 12 shows a close-up view of the jaws in an illustrative gripping device;

FIG. 13 shows an illustrative arrangement for a V-shaped clamping surface in a gripping device;

FIG. 14 shows opposed gripping surfaces in accordance with an aspect of the invention gripping an optical fiber having a first diameter;

FIG. 15 shows the clamping surfaces of FIG. 14 engaged with an optical fiber having a second diameter smaller than the first diameter; and

FIG. 16 shows a pair of gripping devices mounted to a common frame in a manipulation apparatus.

### DETAILED DESCRIPTION

Various aspects of the invention are described below with reference to several illustrative embodiments. It should be understood that not all aspects of the invention are limited to the specific, illustrative embodiments described herein. Instead, aspects of the invention may be used with any suitable apparatus and in any suitable method or environment.

In one illustrative embodiment, an optical device and its associated optical components and optical fibers are carried on a work pallet. One or more manipulators may pick an optical fiber from the work pallet so that a processing station may perform an operation on the optical fiber, e.g., as part of an optical device fabrication process. As an example, the processing station may include, but is not limited to, a cutting, stripping, cleaving, cleaning, fusion splicing, recoating or other device that performs one or more operations on an optical fiber. Once operations are completed, a manipulator may return the optical fiber to the work pallet. Such automated processing can result in optical connections being made between optical components in an optical device without human intervention.

In one illustrative embodiment, optical fibers may have a portion fixed to the work pallet and a free end opposite the fixed portion that is movable relative to the work pallet. A manipulator may pick the free end of the optical fiber from the work pallet and move the free end to a processing station while the fixed portion remains fixed to the work pallet. In addition, the processing station may perform one or more operations on the free end of the optical fiber while the fixed portion of the fiber remains fixed to the work pallet. After the operation(s) is complete, a manipulator may return the free end to the work pallet.

Picking, delivering, returning and other movement of the free end of the optical fiber may be performed by one or more manipulators. If two or more manipulators are used to move a free end of an optical fiber, the manipulators may handoff the optical fiber to each other. Optical fiber handoffs may be performed by interlacing or otherwise positioning one or more gripping devices in the manipulators near each other so that an optical fiber grasped by one manipulator may be grasped by a second manipulator and taken from the first manipulator.

By picking optical fibers from the work pallet and performing operations while a portion of the optical fiber remains fixed to a work pallet, components in an optical device may be optically connected while the components remain fixed to a common circuit board, chassis or other carrier. As a result, the components may be handled as little as possible, possibly preventing damage to the components.

In one embodiment, a work pallet having one or more optical fibers may be positioned below one or more optical fiber processing stations, e.g., so that optical fiber free ends are picked from the work pallet and carried upward for delivery to a processing station. Such relative positioning of the work pallet and the processing stations may have advantages such as allowing for a shorter length of the free end of the optical fiber than otherwise possible, e.g., a length of the free end up to 50 centimeters. That is, other relative arrangements of the processing station(s) and the work pallet may require relatively long lengths of optical fibers on the work pallet, potentially increasing costs (due to the extra optical fiber required), increased processing times (due to additional distance that the fiber must be moved from the work pallet for operations to be performed on the fiber), increased size in the work pallet (to accommodate additional lengths of optical fiber), tangling of the longer optical fibers on the work pallet and/or during movement, and so on.

In another embodiment, two or more processing stations may perform operations on optical fibers picked from a same work pallet simultaneously or nearly simultaneously. By performing operations on different optical fibers approximately simultaneously, an improvement in processing throughput may be obtained. In another embodiment, an optical fiber may be picked from a work pallet and be processed by two separate processing stations before being returned to the work pallet. By performing two or more operations on an optical fiber via only one pick from the work pallet, processing rates may be improved. This is in contrast to systems in which optical fibers are picked and replaced for each processing station. In another embodiment, the work pallet may be moved relative to one or more processing stations while an optical fiber is being processed by a processing station(s). Movement of the work pallet during processing may also result in increased production rates since the work pallet may be suitably moved during processing to a position for a next operation, such as picking from the work pallet, or return of an optical fiber to the work pallet.

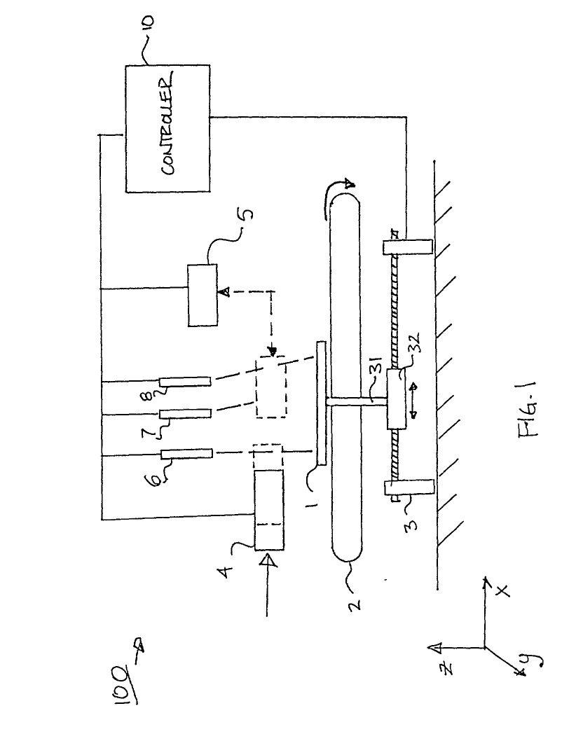

FIG. 1 is a front view, schematic diagram of an illustrative embodiment of an optical device processing system 100 in accordance with the invention. In this illustrative embodiment, a work pallet 1 is configured to carry one or more components of an optical device, including one or more optical fibers, and is moved into and out of the system 100 by a transport. Although the transport may include any suitable device(s) to move the work pallet 1, in this embodiment, the transport includes a conveyor 2. The conveyor 2 provides gross movement of the work pallet 1 within the system 100, e.g., feeding of the work pallet 1 from one side of the system 100 and removing the work pallet 1 to the opposite side of the system 100. As an example, the work pallet 1 may be provided from the left as shown in FIG. 1 by any suitable means, such as by hand or an automated feeding device. The automated feeding device may have a plurality of work pallets 1 stored ready for feeding to the conveyor 2 at an appropriate time.

The conveyor 2 may carry the work pallet 1 within the system 100 to a position in which another portion of the transport, a moveable stage 3, may engage the work pallet 1 and move the work pallet 1 in a more controlled way. In this embodiment, the stage 3 includes a stage carriage 32 that is moved horizontally in an X direction by a drive mechanism such as a ball screw mechanism. The carriage 32 includes arms 31 that selectively extend upward to engage and carry the work pallet 1. As a result, the stage 3 may move the work pallet 1 in a finely controlled manner so that the work pallet 1 can be precisely positioned, e.g., so that optical fibers on the work pallet 1 may be accurately picked from and placed on the work pallet 1 by one or more manipulators in the system 100.

Although in this illustrative embodiment, the transport that moves the work pallet 1 includes the conveyor 2 and the stage 3, the transport may include any suitable devices to move the work pallet 1 in a desired way. For example, the stage 3 may be eliminated and the conveyor 2 configured to move the work pallet 1 in a suitable way. Conversely, the conveyor 2 may be eliminated and the stage 3 may perform all movement of the work pallet 1 within the system 100. Alternately, the transport may include a robotic handling system, or any other suitable device or combination of devices to move the work pallet 1. As yet a further option, the work pallet 1 may remain stationary in the system 100 during all phases of processing.

In this illustrative embodiment, the processing system 100 includes two processing devices that perform one or more operations on optical fibers picked from the work pallet 1: a first optical fiber processing station 4 and a second optical fiber processing station 5. Although various aspects of the invention are not limited to any specific operations performed by the processing stations, in this illustrative embodiment, the first optical fiber processing station 4 includes a fusion processing device adapted to fuse two optical fiber ends together in a way suitable to allow optical communication between the fibers, and the second optical fiber processing station 5 includes a recoating station that forms a protective polymer coating over exposed optical fibers fused by the fusion head in the first processing station 4. Such fusion and recoat processes are well-known in the art and are not described in detail herein. Further details regarding a recoating device that may be used in the system 100 are provided in U.S. patent application Ser. No. ______, entitled “Method and Apparatus for Recoating Optical Fiber”, filed Oct. 2, 2001, (bearing Attorney Docket No. K0480/7007), which is hereby incorporated by reference in its entirety. It should also be understood that the system 100 may include any suitable number of processing stations, i.e., one or more stations, that perform any suitable processes such as stripping, cleaning, cleaving, fusing, recoating, testing, and so on.

Although not all aspects of the invention are limited to any particular number of manipulators, the system 100 in this embodiment includes three manipulators 6, 7 and 8 that handle optical fibers supported by the work pallet 1. In this illustrative embodiment, a first manipulator 6 picks a free end of an optical fiber from the work pallet 1 and delivers the free end of the optical fiber to the fusion processing station 4. As mentioned above, the work pallet 1 may include one or more optical fibers that have a portion fixed to the work pallet 1 and have a free end opposite the fixed portion. Thus, the first manipulator 6 may pick the free end of the optical fiber from the work pallet 1 and deliver the free end to the first processing station 4 to have one or more operations performed on the fiber while the fixed portion remains secured to the work pallet 1. In this illustrative embodiment, the first processing station 4 performs a fusion process that typically involves joining two optical fibers together. Thus, the manipulator 6 in this embodiment picks the free ends of two optical fibers on the work pallet 1 that are to be joined together and delivers the free ends to the first processing station 4. The first manipulator 6 may pick and deliver the optical fibers in any suitable way, such as by a robotic handling device or other apparatus.

In this illustrative embodiment, the first manipulator 6 picks the free end of two optical fibers from the work pallet 1 and lifts the free ends sufficiently so that the first processing station 4 may move toward the right to the position shown in dashed line in FIG. 1. The first manipulator 6 may then move downward to deliver the optical fibers to the first processing station 4. Of course, it will be understood that the first processing station 4 need not move in the specific direction shown or in any direction at all relative to the work pallet 1, and the first manipulator 6 may deliver the optical fibers simultaneously or one at a time to the first processing station 4.

After the optical fibers are processed by the first processing station 4, e.g., the free ends of the two optical fibers picked from the work pallet 1 are joined together by a fusion process, the optical fibers may be delivered to the second processing station 5, e.g., which may include a recoating device. Delivery of the optical fibers to the second processing station 5 may be performed by the first manipulator 6, e.g., if only one manipulator is included in the system 100, or by a second manipulator 7. The second manipulator 7 may pick the optical fibers from the first processing station 4 during or after processing and carry these fibers to the second processing station 5, or the second manipulator 7 may perform a handoff operation with the first manipulator 6.

A handoff operation may be performed by moving the first manipulator 6 sufficiently near the second manipulator 7 while grasping the optical fiber. While the first manipulator 6 holds the optical fiber, the second manipulator 7 may grasp the optical fiber, whereupon the first manipulator 6 may release the optical fiber. The second manipulator 7 may then carry the optical fiber to the second processing station 5, perform a handoff with the third manipulator 8, return the optical fiber to the work pallet 1, and so on.

In this illustrative embodiment, the first manipulator 6 hands an optical fiber off to the second manipulator 7 after processing by the first processing station 4 is complete. The second manipulator 7 then delivers the optical fiber to the second processing station 5 after the station 5 has moved to the position shown in dashed line in FIG. 1. As with the first processing station 4, the second processing station 5 need not move in the particular way shown or in any way at all relative to the work pallet 1. Although the second processing station 5 may perform any suitable operation, in this embodiment the second processing station 5 performs a recoat operation on the fused optical fiber ends. The second processing station 5 may also perform a tension or pull test on the fused and recoated optical fibers to ensure that the fusion process has been performed properly. When processing is complete, the second manipulator 7 may remove the optical fibers from the second processing station 5, and handoff the optical fibers to the third manipulator 8 so that the third manipulator 8 may return the optical fibers to the work pallet 1. In this embodiment, the second processing station 5 moves to the position shown in solid line in FIG. 1 after processing is complete so that the third manipulator 8 may have a clear path to return the optical fibers to the work pallet 1.

One aspect of the invention illustrated in the FIG. 1 embodiment is that operations are performed on optical fibers picked from the work pallet 1 by at least one processing station that is positioned above the work pallet. This is in contrast to placement of a processing station in other locations relative to the work pallet 1, although such variations in processing station placement may be used with other aspects of the invention. However, in this aspect of the invention, placement of a processing station above the work pallet 1 allows optical fibers to have a portion that remains secured to the work pallet while having a free end of a relatively shorter length that is operated on by the processing station. For example, if a processing station were placed alongside, or within a same plane of the work pallet 1, the free ends of optical fibers may need to be longer than that required in the FIG. 1 embodiment to allow the free ends of the optical fibers to be moved to the processing station. This additional optical fiber length may result in increased costs due to excess optical fiber length not needed for optical device operation, an increase in size of work pallets to accommodate the excess optical fiber length, possible tangling or other problems in managing the increased length of optical fibers, and so on.

Another aspect of the invention illustrated in FIG. 1 is that two or more processing stations may perform operations on separate optical fibers secured to a same work pallet at approximately the same time. For example, the first processing station 4 may fuse two optical fiber ends together while a second pair of fused optical fiber ends are recoated by the second processing station 5. Such a parallel processing arrangement may increase throughput of the system 100 since separate operations may be simultaneously, or approximately simultaneously, performed on separate optical fibers with respect to a single work pallet. This is in contrast to arrangements in which optical fibers or groups of optical fibers are serially processed by separate processing stations. It should be understood, however, that processing stations in the system 100 according to some aspects of the invention may perform operations serially on optical fibers picked from a same work pallet.

Another aspect of the invention illustrated in the FIG. 1 embodiment is that an optical fiber may be picked a single time from the work pallet, processed by two or more processing stations, and then returned to the work pallet. This is in contrast to arrangements in which an optical fiber is picked from and returned to a work pallet one time for each processing station. Such additional pick and return operations may decrease throughput of a system 100.

Another aspect of the invention illustrated in the FIG. 1 embodiment is that the work pallet may be moved, e.g., by the stage 3 during processing of one or more optical fibers secured to the work pallet. For example, after the first manipulator 6 picks a pair of optical fibers from the work pallet 1 and delivers the optical fibers to the first processing station 4, the stage 3 may move the work pallet 1 in the X direction as shown in FIG. 1 to position a next pair of optical fibers for picking by the first manipulator 6 after processing of the first pair is complete. Such movement may suitably position the work pallet 1 so that the third manipulator 8 may successfully return a processed optical fiber to the work pallet 1.

In this illustrative embodiment, operations of the various components of the system 100 are controlled by a controller 10. The controller 10 may be a general purpose data processing system, such as a suitably programmed general purpose computer, or network of general network computers and other associated devices, including communication devices and/or other circuitry or components necessary to perform the desired input/output or other functions. The controller 10 may include a single, centralized system that generates and outputs all control signals to the various components in the system 100, or may include a more decentralized control architecture. For example, each component in the system 100 may have a control node that controls all operations of the associated component under the direction of an overall system controller. The controller 10 can also be implemented, at least in part, as a single special purpose integrated circuit (e.g., an Application Specific Integrated Circuit or ASIC), or an array of ASICs each having a main or central processor section for overall, system level control and separate sections dedicated to performing various different specific computations, functions and other processes under the control of the central processor section. The controller 1 can also be implemented using a plurality of separate, dedicated programmable integrated or other electronic circuits or devices, e.g., hard wired electronic or logic circuits, such as discrete element circuits or programmable logic devices. The controller 1 may include any other suitable devices, such as one or more information display devices (e.g., a computer monitor or printer), user input devices, such as keyboards, user pointing devices, touch screens or other user interfaces, data storage devices, such as volatile memory, communication devices or other electronic circuitry or components. Although the controller 10 is shown as a single centralized unit, the controller may be implemented by two or more discrete control systems, if desired. Communication between the various components in the system 100 may be performed using any suitable communications system, whether wired or wireless or a combination thereof, using any communications protocol, data format or other scheme to transmit information.

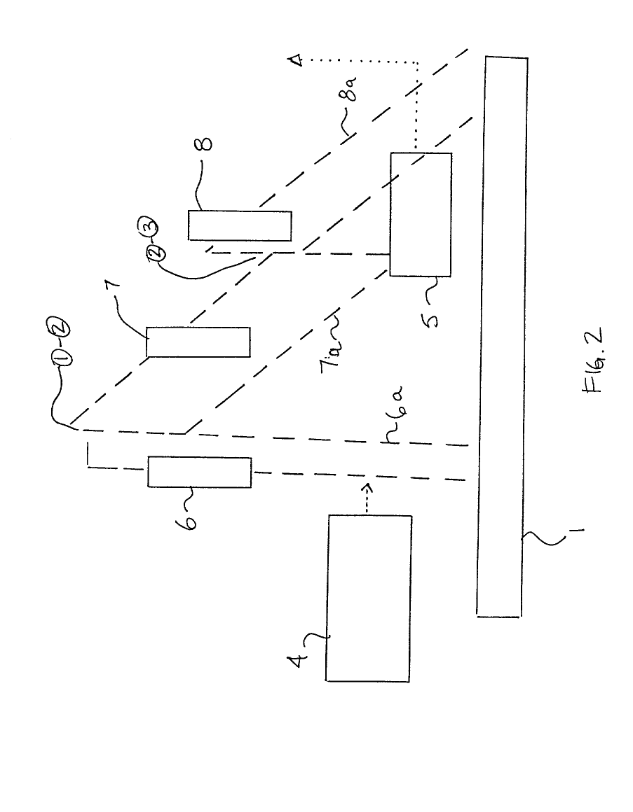

FIG. 2 is a schematic diagram showing how the first, second and third manipulators 6, 7 and 8 may be configured to move in an illustrative embodiment. The first manipulator 6 has an approximately rectangularly-shaped workspace 6a within which may move a portion of the first manipulator 6 that handles an optical fiber. That is, portions of the first manipulator 6 that do not directly contact a portion of the optical fiber may move outside of the workspace 6a. However, portions of the manipulator 6 that contact an optical fiber, such as one or more gripping devices that actually grip the fiber, may be restricted to movement within the work area 6a so that the fixed portion of the optical fiber is not pulled from the work pallet 1 or the optical fiber otherwise damaged by moving the free end of the fiber too far away from the work pallet 1. Thus, the workspace 6a of the manipulator 6, as well as the workspaces 7a and 8a of the other manipulators 7 and 8, may be selectively defined based on a length of the free end of fibers on the work pallet 1. The workspace 6a may be defined by mechanical stops, boundary coordinates provided to the manipulator control system, or other suitable means. Of course, it will be appreciated that FIG. 2 illustrates a cross-section of the workspace 6a of the first manipulator 6 as well as the other manipulators, and that respective workspaces of the manipulators extend in a direction perpendicular to the plane of the drawing.

In this illustrative embodiment, the first manipulator 6 may move downward within its respective workspace 6a to pick a pair of optical fibers from the work pallet 1. Although the first manipulator 6 may pick the optical fibers one-at-a-time from the work pallet 1 or in any other suitable way, in this embodiment, the first manipulator 6 simultaneously picks the free ends of two optical fibers that are to be joined together by a fusion process performed by the first processing station 4. In this embodiment, the first manipulator 6 raises the optical fiber away from the work pallet 1 so that the first processing station 4 may move as shown into the workspace 6a of the first manipulator 6. The first manipulator 6 may then position the optical fibers, e.g., by moving downward, so that grippers, clamps or other devices on the first processing station 4 may grasp the optical fibers in preparation for processing. Although the first processing station 4 may include grippers to hold the optical fibers during processing, such grippers or other similar devices are not necessary and the first manipulator 6 may securely hold the optical fibers during processing by the first processing station 4.

Once processing by the first processing station 4 is complete, e.g., the two optical fiber ends are fused together, the first manipulator 6 may grip the optical fibers and move to a suitable position to hand the optical fibers off to the second manipulator 7. This handoff operation may be performed at an interface between the workspace 6a of the first manipulator 6 and the workspace 7a of the second manipulator 7. Thus, the first manipulator 6 may maintain a hold on the optical fibers until the second manipulator 7 has suitably grasped the fibers. At that time, the first manipulator 6 may release the fibers so that the second manipulator 7 may move within its workspace 7a to deliver the fibers to the second processing station 5.

As with the first processing station 4, the second processing station 5 may include clamps or other gripping devices to hold the optical fibers in place during processing so that the second manipulator 7 may release the fibers and move away. Alternately, the second manipulator 7 may retain possession of the fibers during processing. While processing is being performed by the second processing station 5, the first manipulator 6 may be picking another set of optical fibers from the work pallet 1 and delivering them to the first processing station 4. After processing by the second processing station 5 is complete, the second manipulator 7 may retrieve the optical fibers from the second processing station 5 and move to handoff the fibers to the third manipulator 8.

The work pallet 1 may be indexed by the stage 3 to position optical fiber sets for picking by the first manipulator 6 and/or to position the work pallet 1 so that the third manipulator 8 may return optical fibers to the work pallet 1. Indexing may be performed while processing by the first and second processing stations 4 and 5 is ongoing.

Although the workspaces 6a, 7a and 8a are shown to have no overlap, the workspaces 6a, 7a and/or 8a may overlap to any suitable degree. Moreover, the system 100 need not include three manipulators, but instead may have any suitable number of manipulators from one or more. For example, the first manipulator 6 may pick optical fibers, deliver them to the first and second processing stations 4 and 5 and return optical fibers to the work pallet 1. Transfers of optical fibers between processing stations need not include handoffs between manipulators, but instead separate manipulators may retrieve optical fibers directly from processing stations. For example, the first manipulator 6 may deliver optical fibers to the first processing station 4, and when processing is complete, the second manipulator 7 may move to retrieve optical fibers from the first processing station 4.

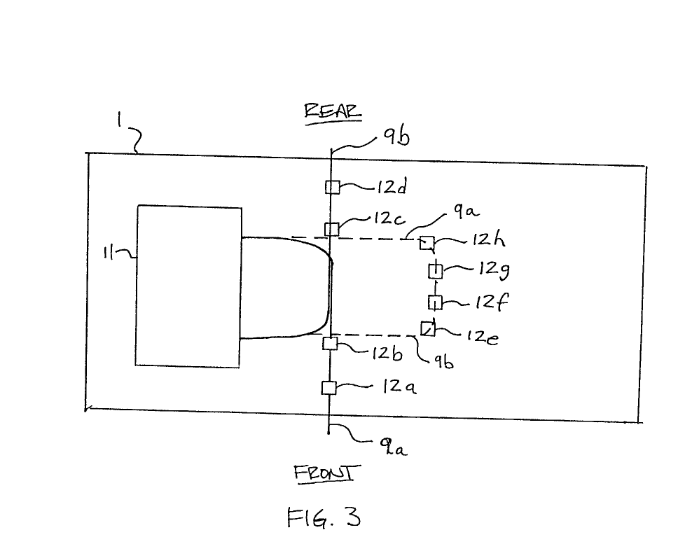

FIG. 3 shows a schematic diagram of a work pallet 1 in one illustrative embodiment. Additional details of a work pallet 1 that may be used with the system 100 are provided in U.S. patent application Ser. No. ______, entitled “Work Pallet for Optical Fiber”, filed Oct. 2, 2001, (bearing Attorney Docket No. K0480/7006), which is hereby incorporated by reference in its entirety. Although the work pallet 1 is shown as having a rectangular shape, the work pallet 1 may have any suitable shape, size, configuration, and may be made of any suitable material or combination of materials. For example, the work pallet 1 may be made of a molded plastic substrate. The work pallet 1 may function as a carrier for an optical device 11 to be fabricated or otherwise processed by the processing system 100.

In FIG. 3, the optical device 11 is shown in a block schematic form, but the optical device 11 may include any suitable number of components including optical amplifiers, sensors, waveguides, multiplexers, storage devices, data processing apparatus, and so on. At least some of the components in the optical device 11 may have one or more optical fibers 9 to carry communication signals to and from the components. For example, an optical amplifier may include one fiber 9 as an input for receiving an optical signal to be amplified, and a second optical fiber 9 for an output of an amplified optical signal. As a result, the optical fibers 9 are secured at least to respective components, and also possibly to a carrier for the optical device 11, such as a circuit board, chassis or other support on the work pallet 1.

A free end of the optical fibers 9 to be processed by the system 100 may be arranged in any suitable way on the work pallet 1 so that they may be picked from the work pallet 1. In this illustrative embodiment, two optical fibers 9a and 9b which are to be joined together by a fusion process are arranged on the work pallet 1 so that they extend from the optical device 11, cross, and are held in place by one or more retainers 12. The retainers 12 may take any suitable form, operate in any suitable way and be arranged in any suitable pattern on the work pallet 1. For example, the retainers 12 may be V-shaped guides in which an optical fiber 12 may rest and be held in place by gravity, or the retainers 12 may include gripping devices having jaws that open and close to positively hold a fiber in place. Opening and closing of the jaws may be caused by actuators that are activated by control signals from a controller on or off of the work pallet 1, by relative movement of a manipulator near the work pallet 1 (e.g., by a gripping device moving a lever or other mechanism that opens or closes the retainers), and so on.

In this embodiment, each optical fiber 9 is held in place by at least two retainers 12 positioned near the end of the optical fibers 9a and 9b. The first optical fiber 9a is retained by retainers 12a and 12b, and the second optical fiber 9b is retained by the retainers 12c and 12d. The optical fibers 9a and 9b may be picked from the work pallet, e.g., by the first manipulator 6, fused by the first processing station 4, recoated and tested by the second processing station 5 and returned to the work pallet 1 to be held by the retainers 12e-12h.

In this embodiment, since the fibers 9a and 9b are joined together by a fusion and recoat process, the configuration of the fibers when returned to the work pallet 1 may be different than before the optical fibers 9 are joined together. In this illustrative embodiment, the joined portion between the optical fibers 9a and 9b may be positioned between the retainers 12f and 12g. Preferably, the retainers 12 and handling by the manipulators maintain the fibers so that the fibers are not bent to any degree below a minimum radius as is well known in the art. Bending optical fibers below a minimum radius can cause damage to the fibers that may prevent the fibers from carrying optical signals in a desired way.

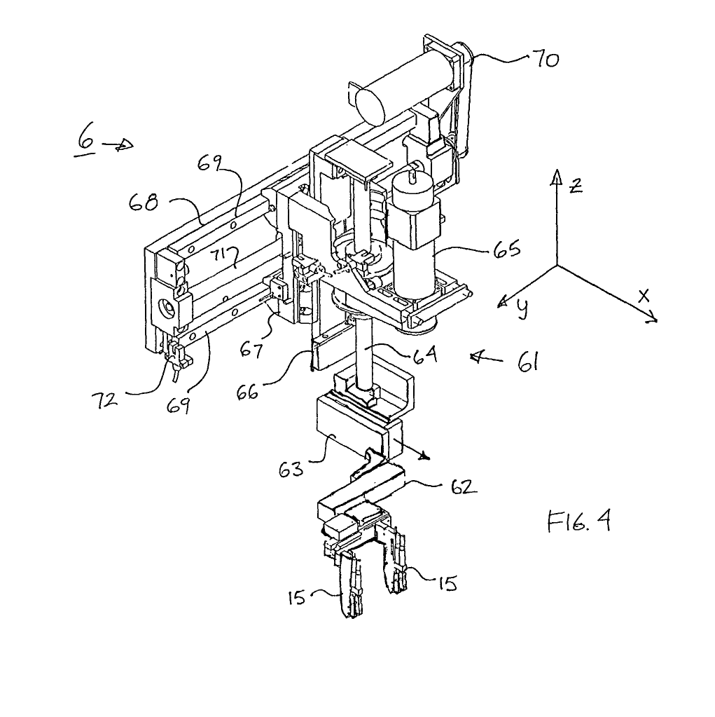

FIG. 4 shows a detailed assembly for a rear portion of the first manipulator 6 in an illustrative embodiment. The first manipulator 6 may also include a second, front portion that is approximately the mirror image of the rear portion shown in FIG. 4. (The relative positions of the front and rear of the first manipulator 6 are consistent with the front and rear of the system 100. FIG. 1 shows a front view of the system 100. The rear of the system 100 is thus located in a Y direction into the plane of the drawing.) For example, the gripping devices 15 that are part of the rear portion of the first manipulator 6 shown in FIG. 4 may be used to pick an optical fiber, such as the optical fiber 9a from the work pallet 1 shown in FIG. 3 positioned near a front of the system 100, i.e., at the lower side of the work pallet 1 in FIG. 3. An unshown front portion of the first manipulator 6 may be used to pick the optical fiber 9b from the work pallet 1 shown in FIG. 3 positioned near a rear of the system 100, i.e., at the upper side of the work pallet 1 shown in FIG. 3. Thus, in this embodiment, the gripping devices 15 of the front and rear portions of the first manipulator 6 cross over each other and pick optical fibers on an opposite side of the work pallet 1. After the optical fibers 9a and 9b are removed from the work pallet 1, the front and rear portions may again move to respective front and rear sides of the work pallet 1 to both allow the first processing device 4 to move forward in position for processing without interference with the optical fibers, as well as to properly position the optical fibers 9a and 9b for fusion processing, recoating and so on. After fusion and recoat processing is complete and the optical fibers are returned to the work pallet 1, the joined fibers are arranged in the retainers 12e-12h so that the optical fiber 9a is positioned on a rear side of the work pallet 1 near the top of the drawing in FIG. 3 and the optical fiber 9b is positioned near a front side of the work pallet 1 toward a lower end of the drawing in FIG. 3. Since the front and rear portions of the first manipulator 6 are nearly identical, mirror images of each other, only the rear portion is shown and described in connection with FIG. 4.

The rear portion of the first manipulator 6 includes a pair of gripping devices 15 that are adapted to grip and manipulate an optical fiber. In this embodiment, the first manipulator 6 includes two gripping devices 15 that are spaced from each other and intended to handle a same optical fiber at the same time. As is described in more detail below, using two or more gripping devices 15 to handle a same fiber may enhance the manipulator's ability to handoff an optical fiber, whether to another manipulator, processing device, etc.

The gripping devices 15 are mounted to a frame 61 that includes a bracket 62 attached to a slider mechanism 63. The slider 63 may be actuated, e.g., by a pneumatic cylinder, to move in the X direction as shown and may provide one degree of freedom for the gripping devices 15. Movement of the gripping devices 15 in the X direction can allow the front and rear portions of the manipulator 6 to cross to opposite sides of the work pallet 1, pick respective optical fibers, and cross again to respective front and rear sides of the system 100. For example, the slider 63 may retract the bracket 62 and gripping devices 15 so that the gripping devices 15 on the front and rear portions of the manipulator 6 may cross to opposite sides of the work pallet 1. The slider 63 may then extend the bracket 62 to pick an optical fiber from the work pallet, retract the bracket 62 to again allow crossover of the manipulator portions, and again extend the slider 63 to position the optical fiber for placement in the first processing station 4.

The slider 63 is mounted to a lower end of a threaded shaft 64 that is moved up and down along a Z axis by a drive mechanism, such as a ball screw drive 65, that is mounted to a carriage guide 67. This ball screw drive 65 may include a servomotor and belt drive that rotates a threaded nut (not shown) engaged with the shaft 64. Rotation of the nut (not shown) causes the shaft 64 to move up or down relative to the ball screw drive 65. An end of the threaded shaft 64 opposite the slider 63 is attached to a carriage 66 that is mounted to slide vertically in the carriage guide 67. Thus, motion of the shaft 64 is guided and supported by the carriage 66 which slides vertically in the carriage guide 67.

The carriage guide 67 is also mounted to slide horizontally in a Y direction along rails 69 mounted to a gantry 68. Movement of the carriage guide 67 along the rails 69 is driven by a threaded shaft 71 and a gantry drive 70. Like the ball screw drive 65, the gantry drive 70 may include a servomotor and belt drive to rotate the threaded shaft 71. The ball screw drive 65 may also include a brake that is normally off while the system 100 is powered, but automatically engages and prevents rotation of the nut when the system 100 is unpowered to prevent the threaded shaft 64 from traveling downward, e.g., in the case of a power failure. Thus, the brake can prevent the downward movement of the shaft 64 and other connected elements of the frame 61 and prevent possible damage to the optical device 11, work pallet 1 or other portions of the system 100 in case of a power failure.

The servomotor arrangements in the first manipulator and other portions of the system 100 may include encoders that indicate motion (both speed and distance) of associated parts of the manipulator. Output of the encoders can be used to precisely control movement of the manipulators. Limit switches or other sensors, such as the switch 72, may be used at time of system start up or at other times to establish/confirm a relative position of different portions of the manipulator. It should be understood that the first manipulator 6 is not limited in any way to the specific arrangements shown in FIG. 4 as other arrangements may be suitable for various aspects of the invention.

One aspect of the invention illustrated in FIG. 4 is that the free end of each optical fiber is handled by two gripping devices, although a single gripping device or three or more gripping devices may be used in other aspects of the invention. In general, the use of two gripping devices 15 may provide for better orientation of the optical fiber upon delivery to a processing station, e.g., to ensure that the optical fiber is properly aligned for processing, and/or to allow handoffs or returns to a work pallet to be successfully performed. For example, optical fibers handled by the manipulators may be thin and droop or curve under their own weight when held by a gripping device 15 in much the same way a thin and flexible rope droops when held in one hand. Using two gripping devices 15 to handle an optical fiber is similar to holding the thin and flexible rope between two hands, i.e., the portion of the optical fiber between the gripping devices is held more straight and may be prevented from drooping. As a result, during a handoff operation, the gripping devices 15 of one manipulator may be interlaced or interdigitated with the gripping devices 15 of another manipulator.

Since the optical fiber to be handed off is held by two or more gripping devices 15, there is a higher likelihood that the optical fiber will be positioned along an axis extending between the jaws of the gripping devices and thus a higher likelihood that the gripping devices 15 of the manipulator to receive the handed off fiber will successfully grip the fiber. The same is true when picking or placing optical fibers on the work pallet 1. For example, when picking the optical fiber 9a from the work pallet 1 (FIG. 3), the gripping devices 15 of the rear portion of the first manipulator 6 may be positioned so that one gripping device 15 is between the retainers 12a and 12b and the other gripping device 15 is positioned near the retainer 12b, but on a side opposite the retainer 12a. By positioning the gripping devices 15 near the retainers 12a and 12b (or near gripping devices 15 in another manipulator during a handoff) the gripping devices 15 intended to receive the optical fiber are more likely to successfully grasp the fiber.

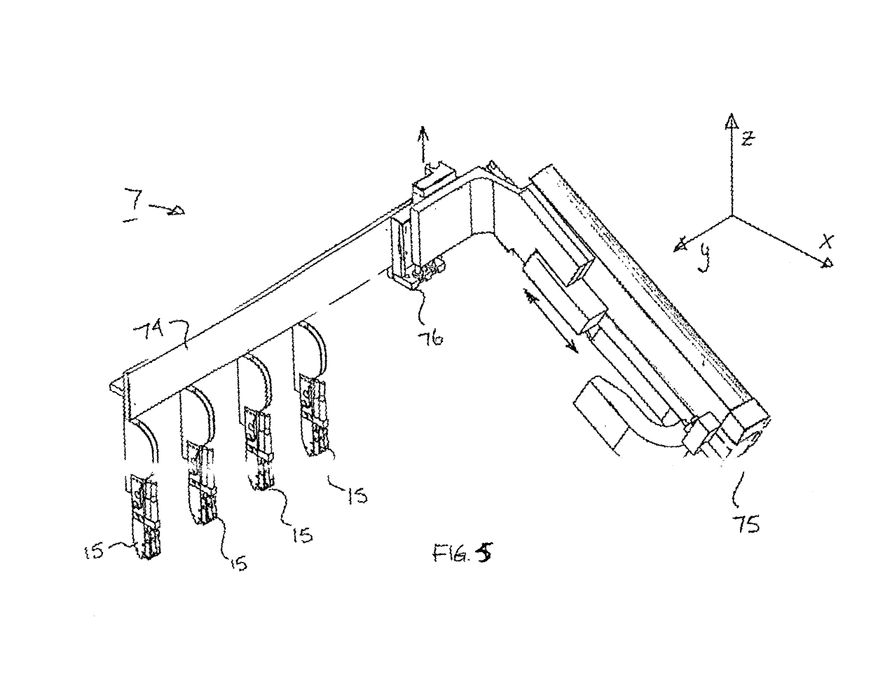

FIG. 5 shows details of an illustrative arrangement for the second manipulator 7. Unlike the first manipulator 6, in this illustrative embodiment, the second manipulator 7 is intended to handle optical fibers that are typically, although not necessarily, joined together by a fusion process at the first processing station 4. Thus, the second manipulator 7 includes gripping devices 15 that are fixed to a common frame 74. This is in contrast to the first manipulator 6 in which two gripping devices 15 in each of the front and rear portions may individually handle and independently move an optical fiber. The second manipulator 7 shown in FIG. 5 also includes an X-Z drive 75 that moves the frame 74 along an angled track within the second manipulator workspace 7a (FIG. 2). A vertical drive 76 is adapted to move the frame 74 vertically in a Z axis direction. The drives 75 and 76 may take any suitable form, such as pneumatic or hydraulic actuators, ball screw or lead screw drive systems, and so on.

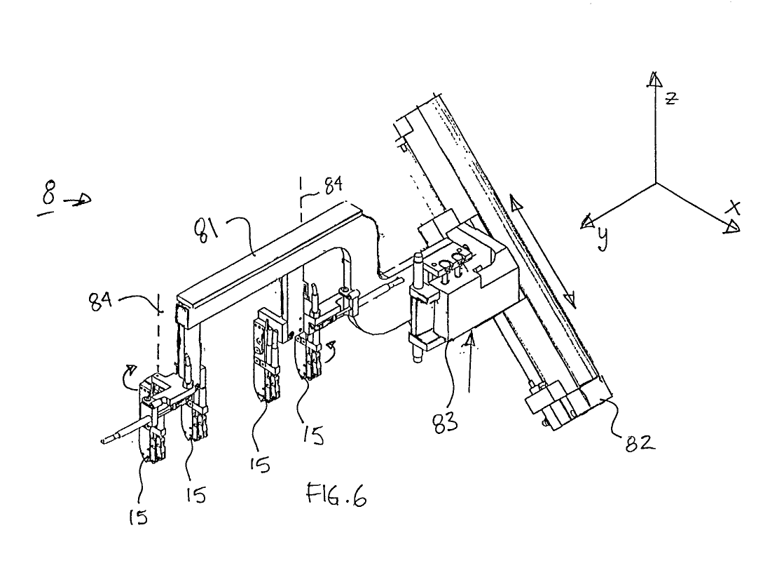

FIG. 6 shows a detailed assembly of an illustrative embodiment for the third manipulator 8, although the third manipulator 8 may take any suitable form. In this illustrative embodiment, the four gripping devices 15 are secured to a frame 81 that may be moved along an X-Z direction by an X-Z drive 82 and vertically along a Z axis direction by a vertical drive 83. As was described above, the third manipulator 8 is arranged to return joined optical fibers to the work pallet 1, such as to a position held by the retainers 12e-12h. Outermost gripping devices 15 on the frame 81 may be arranged so that they may be selectively rotated about respective axes 84. Rotation of the outermost gripping devices 15 may cause a pair of joined optical fibers held by the gripping devices 15 to be suitably bent into a proper arrangement to be held by the retainers 12e-12h or a similar arrangement of retainers 12 on the work pallet 1 (FIG. 3).

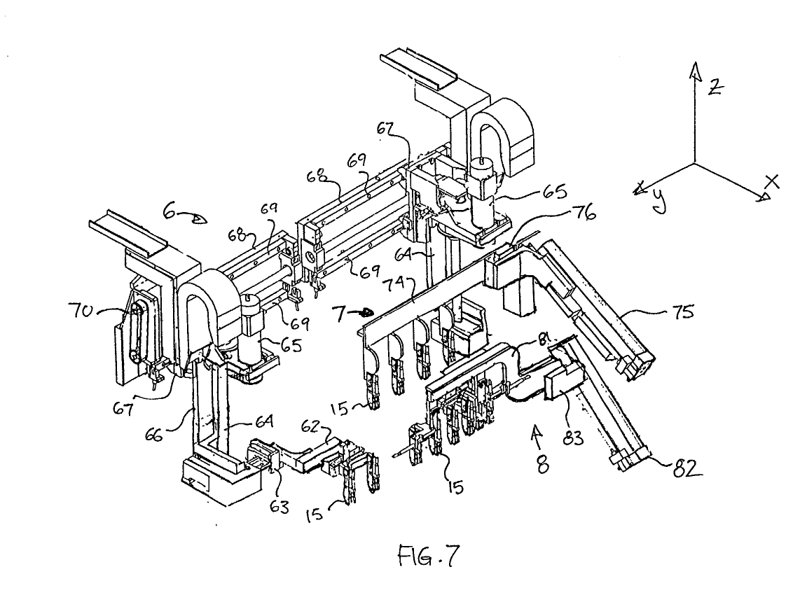

FIG. 7 illustrates one embodiment of an assembly of the first, second and third manipulators 6, 7 and 8 that may be used in the system 100 shown in FIG. 1. Since the various portions of the manipulators 6, 7 and 8 have been described in detail above, no further description is provided here. Instead, FIG. 7 is provided to illustrate one possible arrangement for the first, second and third manipulators 6, 7 and 8. It should be appreciated that a lower end of the rear portion of the first manipulator 6 is partially obscured by the second and third manipulators 7 and 8. As can be seen generally, the first manipulator 6 may be positioned behind the second and third manipulators 7 and 8, and the second manipulator 7 may be positioned between the first and third manipulators 6 and 8 consistent with the arrangement shown in FIG. 2.

As mentioned above, the gripping devices used in the manipulators may vary as desired and in accordance with various aspects of the invention. In one aspect of the invention, an optical fiber may be held between a first clamping surface including a curved surface and a second clamping surface including two planar surfaces arranged at an angle to each other. The curved clamping surface and the two planar surfaces may serve to reliably hold a centerline of differently sized optical fibers in a consistent location, such as along a line that bisects the angle between the two planar surfaces. By reliably positioning the fiber centerline, a manipulator can properly position optical fibers for delivery to a processing station, for handoff to another manipulator, return to the work pallet, and so on.

In another aspect of the invention, the clamping pressure exerted on an optical fiber can be determined based on a fluid pressure supplied to an actuator that controls movement of the clamping surfaces used to hold the fiber. This feature may allow a manipulator to use a same or selectable clamping force on optical fibers since the clamping force exerted may be controlled independently of the size of the optical fiber, relative position of the clamping surfaces, variations in size or surface features on optical fibers, or other variables.

In another aspect of the invention, a manipulator may include first and second jaws respectively having first and second clamping surfaces to hold an optical fiber. An actuator that moves the jaws may control the jaws between three states: an open state, a closed state in which an optical fiber is securely held between the clamping surfaces and a contain state in which an optical fiber is retained in an area between the clamping surfaces, but not securely held between the clamping surfaces. The contain state may be useful, for example, to allow some movement of an optical fiber while the manipulator maintains its ability securely grip the fiber, if necessary.

FIG. 8 shows an illustrative embodiment of a gripping device 15 for use in various aspects of the invention. In this illustrative embodiment, the gripping device 15 includes a base 16 that extends from near a top end of the gripping device 15 to a lower end where a first jaw 19 having a curved clamping surface 20 is arranged to pivot about a pin 23 mounted to the base 16. The lower end of the base 16 forms a second jaw 17 having a V-shaped clamping surface 18. Rotation of the first jaw 19 about the pin 23 is caused by a first actuator 26 that engages with and moves a clevis 25 downward. A first link 24 pivotally mounted at a top end to the clevis 25 and at a lower end to the first jaw 19 transmits movement of the clevis 25 to the first jaw 19. Thus, as the actuator 26 urges the clevis 25 downward, the first link 24 urges the first jaw 19 to rotate about the pin 23 toward the second jaw 17. Although the actuator 26 may cause movement of the first jaw 19 in any suitable way, the actuator 26 may be a pneumatic cylinder operated so that air pressure supplied to the actuator 26 moves the clevis 25 and the first link 24 downward and generates the clamping force between the jaws 17 and 19. Thus, the air pressure supplied to the actuator may define the clamping pressure on an optical fiber gripped between the jaws 17 and 19. The actuator 26 may have a spring return such that when air pressure is released from the pneumatic cylinder, the clevis 25 is retracted and the first jaw 19 rotated to the open position shown in FIG. 8.

A second actuator 30 may be employed to engage with a second clevis 29 to which a second link 28 is rotatably mounted at a top end of the second link 28. The lower end of the second link 28 is pivotally connected to a contain link 27 that is pivotally mounted at a pin 31 to the base 16. As will be described in more detail below, the second actuator 30 controls movement of the contain link 27 so that the first jaw 19 may be placed and maintained in a contain position such that the optical fiber is contained between the jaws 17 and 19, but not firmly held between the jaws. The second actuator 30 in this embodiment includes a pneumatic cylinder, but like the first actuator 26 may include any mechanism such as a hydraulic ram, screw drive, solenoid, or other actuator.

The gripping device 15 may employ one or more sensors to monitor one or more positions or operational conditions. In this illustrative embodiment, a sensor 21 is located in this embodiment near the V-shaped clamping surface 18 on the second jaw 17 so that the presence of an optical fiber held between the jaws 17 and 19 can be detected and a signal representing a presence, or absence, of the fiber provided through leads 22, e.g., to the controller 10. The sensor 21 may detect the presence or absence of an optical fiber in any suitable way, such as by using a photodetector that is shielded from ambient light when the optical fiber is held between the jaws 17 and 19, but exposed to light when the fiber is not present between the jaws 17 and 19. Other sensors may be used to determine the relative positions of the jaws 17 and 19 or other portions of the gripping device 15.

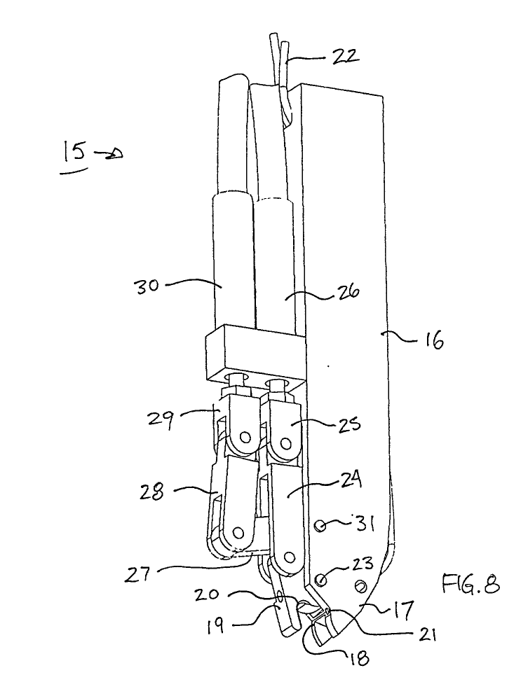

FIG. 9 shows a close up view of the lower end of the gripping device 15 of FIG. 8. As can be seen more clearly in FIG. 9, the second jaw 17 has a pair of extensions 32 that extend from the V-shaped clamping surface 18. These extensions 32 along with a similar extended portion on the first jaw 19, help to guide an optical fiber to the V-shaped clamping surface 18, e.g., as the jaws 17 and 19 are closed. The extensions 32 are separated by a cavity that receives a portion of the first jaw 19 when a fiber is held between the jaws 17 and 19. This enables the V-shaped clamping surface 18 and the curved clamping surface 20 to be brought closely together and grip an optical fiber having a diameter of approximately 150-900 microns. Of course, the gripping device 15 including the jaws 17 and 19 may be configured in any suitable way to grip any size or shape object.

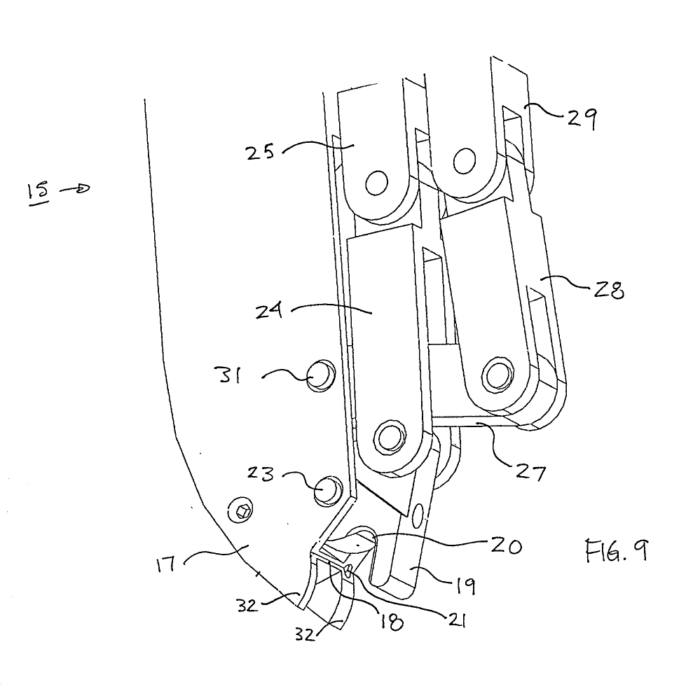

FIG. 10 shows the jaws 17 and 19 of the gripping device 15 in a closed position in which an optical fiber may be held between the clamping surfaces of the jaws 17 and 19. In this embodiment, the clamping surfaces of the jaws 17 and 19 are brought together by movement of the clevis 25 and the first link 24 downward, or toward the jaws 17 and 19. This movement causes the first jaw 19 to rotate about the pin 23 relative to the second jaw 17 and brings the clamping surfaces together. No operation of the actuator 30 is necessary in this embodiment to move the jaws 17 and 19 to a closed state. As mentioned above, since the actuator 26 in this embodiment is a pneumatic cylinder, the air pressure supply to the actuator 26 may be used to define the clamping force exerted by the jaws 17 and 19 on an optical fiber held between the jaws. This arrangement may allow the clamping pressure to be defined independent of a range of motion of the first jaw 19 relative to the second jaw 17 or other features, and may be useful, for example, when the gripping device 15 is intended to handle optical fibers of various sizes.

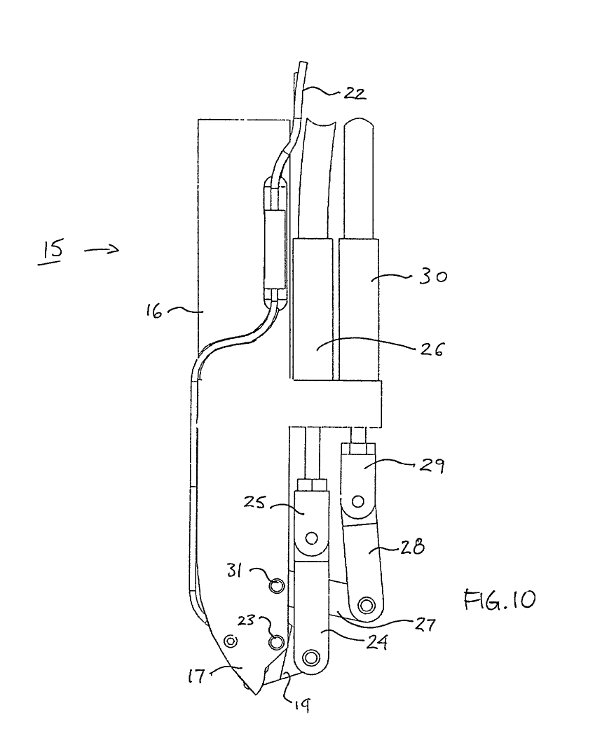

FIG. 11 shows the jaws 17 and 19 of the gripping device 15 in a contain state. That is, in this state, an optical fiber may be contained in a region between the clamping surfaces 18 and 20, but not firmly held between the clamping surfaces 18 and 20. Thus, the optical fiber may be loosely held and confined to a particular region when the gripping device 15 is in a contain state. The contain state may be used, for example, when a manipulator delivers an optical fiber to a processing station. Thus, the manipulator may deliver the fiber and then hold the fiber in a contain state so that grippers in the processing station can grip and manipulate the fiber, e.g., rotate the fiber before fusion in the case of polarizing maintaining fibers. By maintaining the fibers in a contain state, the manipulator can be certain that the fiber will not be released from the jaws 17 and 19 while allowing some freedom of movement of the fiber.

Although the jaws 17 and 19 may be moved and held in a contain state using any suitable mechanism, in this embodiment, a first jaw 19 is held in a contain state by the contain link 27 contacting the first jaw 19 near a pin 33 that connects the first jaw 19 and the first link 24 together. Thus, while the first jaw 19 is in a closed state as shown in FIG. 10, the actuator 30 extends, urging the clevis 29 and the second link 28 downward toward the first jaw 19. This rotates the contain link 27 around the pin 31. When the actuator 30 is extended sufficiently to properly position the contain link 27, the air pressure supplied to the actuator 26 may be released, allowing the clevis 25, first link 24 and first jaw 19 to retract, e.g., under the force of a retraction spring in the actuator 26. However, complete retraction of the first jaw 19 to an open state is stopped by the contain link 27 in the position shown in FIG. 11 to maintain the first jaw 19 in a contain state.

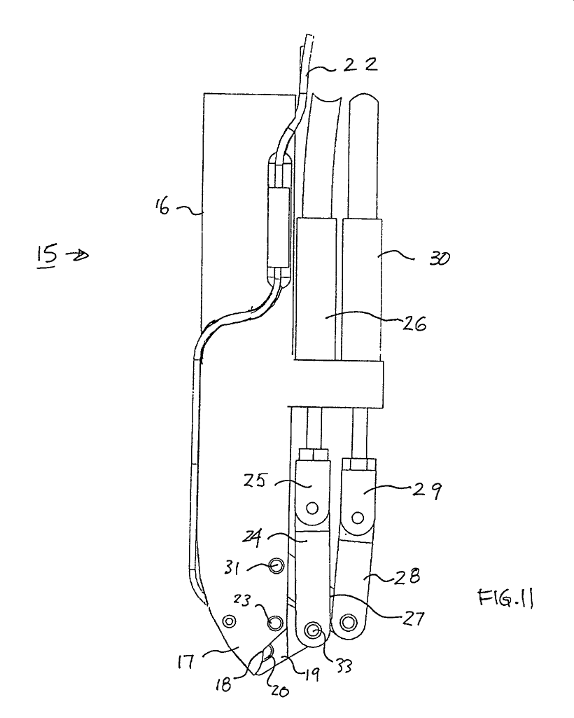

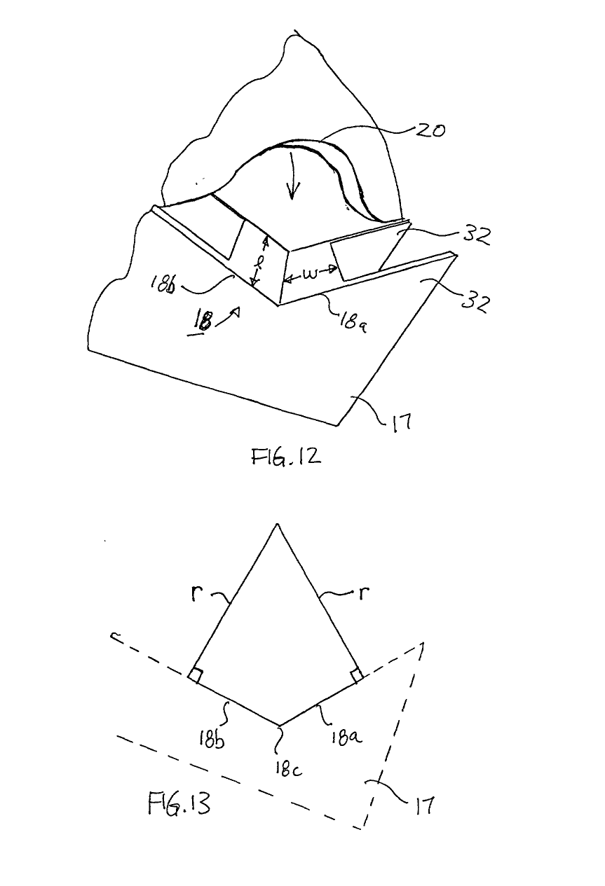

FIG. 12 shows a close-up view of the clamping surfaces 18 and 20 in an illustrative embodiment of the gripping device 15. The V-shaped clamping surface 18 may include two approximately planar surfaces 18a and 18b arranged at an angle relative to each other. The angle between the surfaces 18a and 18b may be any suitable angle, such as between 120 and 150 degrees, and in one embodiment approximately 135 degrees. The surfaces 18a and 18b may have a same width w suitable for clamping an optical fiber, such as a width w of 1 millimeter or less, or in one embodiment approximately 0.1 to 0.2 millimeters. The surfaces 18a and 18b may have a length I suitable for clamping an optical fiber, such as 2-15 millimeters, or in one embodiment approximately 5 millimeters. The length I may be the same as the width of the second jaw 17, which in one embodiment is less than about 0.5 inches. A more narrow width of the second jaw 17 may enhance the ability of the gripping device 15 to handoff fibers to other gripping devices, pick fibers from a work pallet or deliver fibers to a processing station because a wider second jaw 17 may interfere with other gripping devices, retainers or other devices during the fiber transfer.

The clamping surfaces 18a and 18b may be arranged to help ensure that optical fibers are not damaged when held by the clamping surfaces. In one aspect of the invention, the clamping surfaces 18a and 18b may be arranged so that perpendicular lines extending from an outer end of each of the planar surfaces intersect at a point spaced at least a distance equal to a radius of a largest optical fiber to be handled by the clamping surface. For example, as shown in FIG. 13, the clamping surfaces 18a and 18b of the second jaw 17 may be arranged so that perpendicular lines that extend from outer ends of the clamping surfaces 18a and 18b intersect at a point beyond the centerpoint of a largest optical fiber to be handled by the clamping surfaces 18a and 18b. That is, the length r of the perpendicular lines may be equal to or greater than the radius of the largest optical fiber to be handled by the clamping surfaces 18a and 18b. In this way, pinching or other unequal force distribution on the fiber may be avoided, thus avoiding potential damage to the fiber during handling.

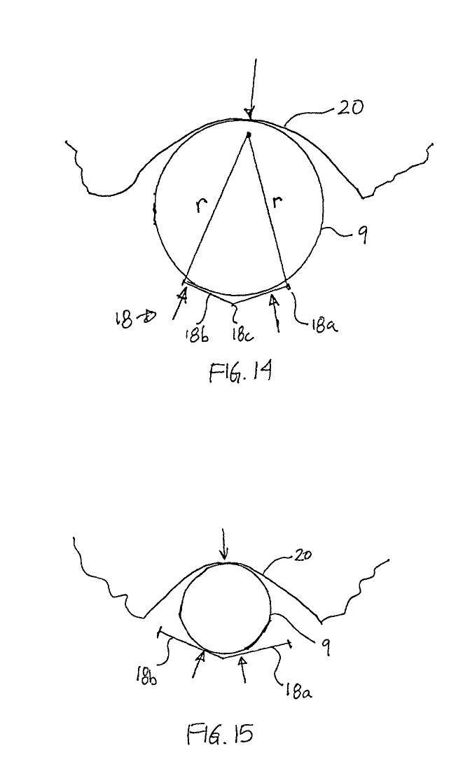

FIG. 14 shows a schematic view of the clamping surfaces 18 and 20 holding an optical fiber 9. In this illustrative arrangement, the optical fiber 9 is held at three points of contact between the clamping surfaces 18 and 20. That is, the surfaces 18a, 18b and 20 each contact the fiber 9 at one point along the surface. It is to be appreciated that since the surfaces 18a, 18b and 20 extend in a direction perpendicular to the plane of the drawing in FIG. 14, the surfaces 18a, 18b and 20 actually contact the fiber 9 at lines of contact rather than at single points. However, for simplicity, a 3-point contact is used to refer to the way in which the surfaces 18a, 18b and 20 engage the optical fiber 9.

Like that in FIG. 13, in this illustrative embodiment, perpendicular lines extending from the outer end of the surfaces 18a and 18b intersect at a point separated at a distance r that is at least equal to the radius of the optical fiber 9. In this way, the points of contact between the optical fiber and the surfaces 18a and 18b are located inward from the outer ends of the surfaces 18a and 18b toward the vertex 18c. This arrangement may avoid the creation of pinch points or other applications of force on the fiber 9 that may cause damage to the fiber 9. For example, if the optical fiber 9 had a radius much larger than r in the arrangement shown in FIG. 14, the fiber 9 would engage with the surfaces 18a and 18b only at the outer ends of the surfaces 18a and 18b. This may cause sharp edges at the outer ends of the surfaces 18a and 18b to cut into the fiber 9 and possibly cause damage during clamping.

The 3-point contact arrangement shown in FIG. 14 also ensures that fibers 9 are consistently positioned relative to the surfaces 18a and 18b regardless of optical fiber diameter. For example, in this arrangement, a center of the optical fiber 9 may be reliably positioned along a line that passes through the vertex 18c and bisects the angle between the surfaces 18a and 18b regardless of the diameter of the optical fiber 9. The curved surface of the clamping surface 20 may also allow the gripping device 15 to accommodate a variety of differently sized optical fibers 9 since the curved surface 20 may generally have a radius that is larger than that of the optical fiber 9, thereby assuring a single point of contact between the fiber 9 and the clamping surface 20.

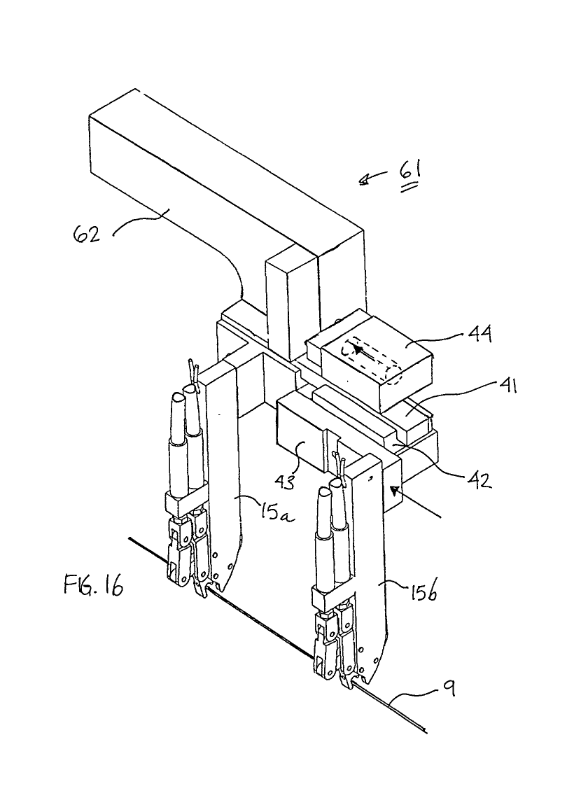

FIG. 15 shows the clamping surfaces 18a, 18b and 20 when handling an optical fiber 9 having a diameter smaller than that in FIG. 14. As can be seen, with this illustrative arrangement of clamping surfaces, differently sized optical fibers 9 may be accommodated by simply adjusting the separation between the clamping surfaces 18a, 18b and 20, e.g., by rotating the first jaw 19 varying amounts relative to the second jaw 17.

As mentioned above, manipulators in accordance with at least one aspect of the invention may include two or more gripping devices to handle a free end of an optical fiber. In one aspect of the invention, the two or more gripping devices used to handle one free end of an optical fiber may be arranged to move independently of each other. For example, FIG. 16 shows an illustrative arrangement in which one of the gripping devices 15 may be moved in an axial direction relative to the other gripping device 15 where the axial direction is parallel to a longitudinal axis of an optical fiber 9 grasped by the gripping devices 15. Such axial movement may, for example, allow the gripping devices 15 to tension an optical fiber held between the gripping devices 15. Tensioning of the optical fiber may cause the fiber to align itself along a more straight line between the jaws of the gripping devices 15 and thus more properly align the fiber for placement in a processing station, for handoff to another manipulator, for placement in a work pallet 1, or other. For example, the arrangement shown in FIG. 16 may be used in the first manipulator 6 so that the optical fiber 9 may be slightly tensioned after being picked from a set of retainers 12 on the work pallet 1.

In the illustrative embodiment shown in FIG. 16, the two gripping devices 15a and 15b are coupled to and move with a bracket 62 that is part of a frame 61 of the manipulator 6. A first gripping device 15a is fixed in place relative to the bracket 62 while a second gripping device 15b is mounted to the bracket 62 so that it may slide axially, i.e., in a direction approximately parallel to a longitudinal axis of the fiber 9. Although such movement may be accomplished using any suitable mechanism, in this embodiment, a rail 41 is fixed to the bracket 62 and extends axially away from the bracket 62. A linear roller bearing 42 is carried by the rail 41 and arranged so that the bearing 42 may slide axially on the rail 41. The linear roller bearing 42 is fixed to a slidable mount 43 to which the second gripping device 15b is mounted. An actuator 44, such as a pneumatic ram, is fixed to the rail 41 and when actuated moves the slidable mount 43 axially relative to the rail 41. The actuator 44 may be arranged in any suitable way, but in this illustrative embodiment includes a pneumatic ram that when actuated urges the slidable mount 43 toward the bracket 62. When the ram is deactivated, a return spring (not shown) urges the slidable mount 43 away from the bracket 62.

When picking a free end of an optical fiber from a work pallet 1, the arrangement shown in FIG. 16 may operate as follows. Initially, the actuator 44 may be operated to move the slideable mount 43 and thus the second gripping device 15b toward the bracket 62. This action may cause any amount of movement of the second gripping device 15b toward the first gripping device 15a, but in this illustrative embodiment, the second gripping device 15b is moved approximately ⅛ inch toward the first gripping device 15a. This amount of movement, at least in this embodiment, is sufficient to remove slack occasionally found in optical fibers mounted in the work pallet 1. Once the second gripping device 15b is moved toward the first gripping device 15a, the first manipulator 6 may move the gripping devices 15 so that they grip an optical fiber 9 on a work pallet 1. Once the jaws on the gripping devices 15 are closed and the optical fiber 9 is firmly held, the actuator 44 may be deactivated, thus allowing the return spring (not shown) to urge the second gripping device 15b away from the first gripping device 15a and tension the portion of the optical fiber 9 between the gripping devices 15. Although any suitable tensioning force may be used, in this embodiment, the return spring applies approximately 4 oz. of force to the second gripping device 15b.

It should be understood that the gripping devices 15 may be arranged to move relative to each other in any suitable way other than the axial movement shown in FIG. 16. For example, the second gripping device 15b may be mounted for rotational movement relative to the first gripping device 15a, such as that shown in FIG. 6. This rotary motion may be used to bend an optical fiber at a radius suitable to avoid damage to the fiber and allow placement of the fiber in a work pallet 1 or other environment.

Although particular embodiments have been described in detail, various modifications and improvements will readily occur to those skilled in the art. Such modifications and improvements are intended to be part of this disclosure and within the spirit and scope of the invention. Accordingly, the description of the illustrative embodiment is by way of example only, and the invention is defined, at least in part, by the following claims and their equivalents.

1. An optical fiber processing apparatus comprising:
a first optical fiber processing station arranged to process at least one optical fiber associated with a work pallet, the at least one optical fiber having a fixed portion fixed to the work pallet and a free end opposite the fixed portion that is movable relative to the work pallet; and
at least one manipulator constructed and arranged to pick the free end of the at least one optical fiber from the work pallet, deliver the free end of the at least one optical fiber to the first optical fiber processing station, and return the free end to the work pallet after processing by the first optical fiber processing station is complete.

2. The apparatus of claim 1, further comprising:
the work pallet; and
a transport adapted to move the work pallet relative to the first optical fiber processing station.

3. The apparatus of claim 1, wherein the first optical fiber processing station is to be positioned above the work pallet when processing the free end of the at least one optical fiber secured to the work pallet.

4. The apparatus of claim 1, further comprising:
a second optical fiber processing station adapted to process the free end of the at least one optical fiber.

5. The apparatus of claim 4, wherein the at least one manipulator includes first and second manipulators, the first manipulator adapted to pick the free end of the at least one optical fiber from the work pallet and deliver the free end to the first optical fiber processing device, the second manipulator adapted to deliver the free end to the second optical fiber processing device after processing by the first optical fiber processing device is complete.

6. The apparatus of claim 5, wherein the at least one manipulator includes a third manipulator adapted to return the free end of the at least one optical fiber to the work pallet after processing by the second optical fiber processing device is complete.

7. The apparatus of claim 6, wherein the third manipulator is constructed and arranged to put at least one strain relief bend in the at least one optical fiber before returning the at least one optical fiber to the work pallet.

8. The apparatus of claim 6, wherein the first and second optical fiber processing stations are to be positioned above the work pallet when processing the free end of the at least one optical fiber associated with the work pallet.

9. The apparatus of claim 5, wherein the first and second manipulators are adapted to move a free end of an optical fiber secured to a work pallet a distance of at most 50 centimeters from the work pallet.

10. The apparatus of claim 5, wherein the first optical fiber processing station includes a fusion bonding device and the second optical fiber processing station includes a recoating device.

11. The apparatus of claim 1, wherein the at least one manipulator includes a pair of gripping devices that are used to grip the free end of the at least one optical fiber at different points along the length of the at least one optical fiber.

12. The apparatus of claim 1, wherein the at least one manipulator is adapted to pick the free end of two optical fibers from the work pallet, deliver the free ends of the two optical fibers to the first optical fiber processing station for approximately simultaneous processing, and return the two optical fibers to the work pallet.

13. The apparatus of claim 12, wherein the first optical fiber processing station includes a fusion bonding device adapted to fuse portions of the free ends of the optical fibers to each other.

14. An optical fiber processing apparatus comprising:
a work pallet transport adapted to move a work pallet configured to support at least one optical fiber with a fixed portion secured to the work pallet and a free end opposite the fixed portion that is movable relative to the work pallet;
a first optical fiber processing station positionable above a work pallet moved by the work pallet transport; and
at least one manipulator adapted to pick the free end of the at least optical fiber from the work pallet, deliver the free end of the at least one optical fiber to the first optical fiber processing station while positioned above the work pallet and return the free end to the work pallet after processing by the first optical fiber processing station is complete.

15. The apparatus of claim 14, wherein the work pallet transport includes a conveyor adapted to move the work pallet relative to the first optical fiber processing station.

16. The apparatus of claim 15, wherein the work pallet transport includes a stage adapted to engage with the work pallet and move the work pallet relative to the first optical fiber processing station.

17. The apparatus of claim 14, further comprising:
a second optical fiber processing station adapted to process the free end of the at least one optical fiber.

18. The apparatus of claim 17, wherein the at least one manipulator includes first and second manipulators, the first manipulator adapted to pick the free end of the at least one optical fiber from the work pallet and deliver the free end to the first optical fiber processing device, the second manipulator adapted to deliver the free end to the second optical fiber processing device after processing by the first optical fiber processing device is complete.

19. The apparatus of claim 18, wherein the at least one manipulator includes a third manipulator adapted to return the free end of the at least one optical fiber to the work pallet after processing by the second optical fiber processing device is complete.

20. The apparatus of claim 19, wherein the third manipulator is adapted to put at least one strain relief bend in the at least one optical fiber before returning the at least one optical fiber to the work pallet.

21. The apparatus of claim 19, wherein the first and second optical fiber processing stations are positioned above the work pallet when processing the free end of the at least one optical fiber associated with the work pallet.

22. The apparatus of claim 18, wherein the first optical fiber processing station includes a fusion bonding device and the second optical fiber processing station includes a recoating device.

23. The apparatus of claim 18, wherein the at least one manipulator includes a pair of gripping devices that are used to grip the free end of the at least one optical fiber.

24. The apparatus of claim 23, wherein the at least one manipulator is adapted to pick the free end of two optical fibers from the work pallet, deliver the free ends of the two optical fibers to the first optical fiber processing station for approximately simultaneous processing, and return the two optical fibers to the work pallet.

25. The apparatus of claim 24, wherein the first optical fiber processing station is a fusion bonding device adapted to fuse portions of the free ends of the optical fibers to each other.

26. An optical fiber processing apparatus comprising:
a work pallet constructed and arranged to support at least one optical fiber with a fixed portion secured to the work pallet and a free end opposite the fixed portion that is movable relative to the work pallet;
a first optical fiber processing station adapted to perform a process on a free end of an optical fiber from the work pallet;
a second optical fiber processing station adapted to perform a process on a free end of an optical fiber from the work pallet; and
at least one manipulator adapted to pick a free end of at least two optical fibers from the work pallet, deliver the free end of at least a first optical fiber to the first optical fiber processing station and deliver the free end of at least a second optical fiber to the second optical fiber processing station so that the first and second optical fiber processing stations substantially simultaneously process the first and second optical fibers.

27. The apparatus of claim 26, wherein the at least one manipulator delivers a free end of at least the first optical fiber from the first optical fiber processing device to the second optical fiber processing device after processing by the first optical fiber processing device is complete and without returning at least the first optical fiber to the work pallet.

28. The apparatus of claim 26, wherein the at least one manipulator includes first and second manipulators, the first manipulator adapted to pick the free end of at least the first optical fiber from the work pallet and deliver the free end to the first optical fiber processing device, the second manipulator adapted to deliver the free end to the second optical fiber processing device after processing by the first optical fiber processing device is complete.

29. An optical fiber processing apparatus comprising:
a work pallet constructed and arranged to support at least one optical fiber with a fixed portion secured to the work pallet and a free end opposite the fixed portion that is movable relative to the work pallet;
a first optical fiber processing station adapted to perform a process on a free end of an optical fiber from the work pallet;
a second optical fiber processing station adapted to perform a process on a free end of an optical fiber from the work pallet; and
at least one manipulator adapted to pick the free end of the at least one optical fiber from the work pallet, deliver the free end of the at least one optical fiber to the first optical fiber processing station for processing, deliver the free end of the at least one optical fiber to the second optical fiber processing station after processing by the first optical fiber processing station is complete without returning the at least one optical fiber to the work pallet, and return the at least one optical fiber to the work pallet after processing by the second optical fiber processing station is complete.

30. The apparatus of claim 29, wherein the first and second optical fiber processing stations are positioned above the work pallet when processing the free end of the at least one optical fiber associated with the work pallet.

31. The apparatus of claim 29, wherein the first optical fiber processing station includes a fusion bonding device and the second optical fiber processing station includes a recoating device.

32. The apparatus of claim 29, wherein the at least one manipulator includes a pair of gripping devices that are used grip the free end of the at least one optical fiber at a same time.

33. The apparatus of claim 29, wherein the at least one manipulator is adapted to pick the free end of two optical fibers from the work pallet, deliver the free ends of the two optical fibers to the first optical fiber processing station for approximately simultaneous processing, and return the two optical fibers to the work pallet.

34. The apparatus of claim 33, wherein the first optical fiber processing station includes a fusion bonding adapted to fuse portions of the free ends of the optical fibers to each other.

35. An optical fiber processing apparatus comprising:
a work pallet transport adapted to move a work pallet configured to support at least one optical fiber with a fixed portion secured to the work pallet and a free end opposite the fixed portion that is movable relative to the work pallet;
a first optical fiber processing station positionable near a work pallet moved by the work pallet transport; and
at least one manipulator adapted to pick the free end of the at least one optical fiber from the work pallet, deliver the free end of the at least one optical to the first optical fiber processing station, and return the free end to the work pallet after processing by the first optical fiber processing station is complete;
wherein the work pallet transport is adapted to move a work pallet during a period in which a free end of at least one optical fiber is removed from the work pallet for processing.

36. The apparatus of claim 35, wherein the first optical fiber processing station is to be positioned above the work pallet when processing the free end of the at least one optical fiber secured to the work pallet.

37. The apparatus of claim 35, further comprising:
a second optical fiber processing station adapted to process the free end of the at least one optical fiber.

38. The apparatus of claim 37, wherein the at least one manipulator includes first and second manipulators, the first manipulator adapted to pick the free end of the at least one optical fiber from the work pallet and deliver the free end to the first optical fiber processing device, the second manipulator delivering the free end to the second optical fiber processing device after processing by the first optical fiber processing device is complete.

39. The apparatus of claim 38, wherein the at least one manipulator includes a third manipulator adapted to return the free end of the at least one optical fiber to the work pallet after processing by the second optical fiber processing device is complete.

40. The apparatus of claim 37, wherein the first and second optical fiber processing stations are to be positioned above the work pallet when processing the free end of the at least one optical fiber associated with the work pallet.

41. The apparatus of claim 37, wherein the first optical fiber processing station includes a fusion bonding device and the second optical fiber processing station includes a recoating device.

42. The apparatus of claim 35, wherein the at least one manipulator includes a pair of gripping devices that are used to grip the free end of the at least one optical fiber at the same time.

43. The apparatus of claim 35, wherein the at least one manipulator is adapted to pick the free end of two optical fibers from the work pallet, deliver the free ends of the two optical fibers to the first optical fiber processing station for approximately simultaneous processing, and return the two optical fibers to the work pallet.

44. A manipulation apparatus for handling optical fibers, the apparatus comprising:
a first clamping surface including a curved surface; and
a second clamping surface including two planar surfaces arranged at an angle with respect to each other;
wherein the first and second clamping surfaces are arranged to be moved toward each other to capture an optical fiber between at least a portion of the curved surface of the first clamping surface and at least a portion of each of the two planar surfaces of the second clamping surface.

45. The apparatus of claim 44, wherein the optical fiber is to be contacted at a first line of contact on the first clamping surface, at a second line of contact on one of the planar surfaces of the second clamping surface, and at a third line of contact on the other of the planar surfaces of the second clamping surface.

46. The apparatus of claim 44, further comprising:
a first jaw carrying the first clamping surface; and
a second jaw carrying the second clamping surface.

47. The apparatus of claim 46, wherein the first and second jaws are pivotally mounted relative to each other so that pivoting of one of the first and second jaws causes the first and second clamping surfaces to move toward each other.

48. The apparatus of claim 47, further comprising:
an actuator that uses air pressure to cause relative pivoting of the first and second jaws.

49. The apparatus of claim 48, wherein the air pressure defines a clamping force created by the first and second jaws.

50. The apparatus of claim 46, wherein the first and second jaws may be moved relative to each other between three states including an open state in which an optical fiber may be positioned between the first and second clamping surfaces, a contain state in which an optical fiber is contained within an area enclosed by the first and second jaws, and a closed state in which an optical fiber is securely held between the first and second clamping surfaces.

51. The apparatus of claim 44, further comprising:
a base;
a first jaw pivotally mounted to the base and including the first clamping surface;
a second jaw supported by the base and including the second clamping surface and
a first actuator, linked to the first jaw, adapted to move the first jaw relative to the second jaw between open and closed states.

52. The apparatus of claim 51, further comprising:
a contain link pivotally mounted to the base; and
a second actuator coupled to the contain link, the second actuator pivoting the contain link so as to maintain the first jaw in a contain position in which an optical fiber is contained between the first and second jaws, but not firmly held between the first and second clamping surfaces.

53. A manipulation apparatus for handling optical fibers, the apparatus comprising:
a first clamping surface;
a second clamping surface; and
an actuator adapted to cause at least one of the first and second clamping surfaces to move and clamp an optical fiber between the first and second clamping surfaces, the actuator being driven at least in part by a fluid under pressure so that the fluid pressure controls a clamping force of the first and second clamping surfaces on the optical fiber.

54. The apparatus of claim 53, wherein the actuator is a pneumatic cylinder that is driven by pressurized air.

55. The apparatus of claim 54, wherein the pneumatic cylinder is driven by air pressure to move at least one of the first and second clamping surfaces to clamp an optical fiber, and the pneumatic cylinder includes a resilient member that moves one of the first and second clamping surfaces apart to free the optical fiber when air pressure supplied to the actuator is reduced.

56. The apparatus of claim 53, wherein the first clamping surface includes a curved surface, and the second clamping surface includes a pair of planar surfaces arranged at an angle with respect to each other.

57. A manipulation apparatus for handling optical fibers, the apparatus comprising:
a first jaw having a first clamping surface;
a second jaw having a second clamping surface; and
an actuator adapted to cause the first and second clamping surfaces to move between three operational states including an open state in which an optical fiber is not held between the first and second clamping surfaces, a closed state in which an optical fiber is securely clamped between the first and second clamping surfaces, and a contain state in which an optical fiber is restrained within an area near the first and second clamping surfaces, but not securely clamped between the first and second clamping surfaces.

58. A manipulation apparatus for handling optical fibers, the apparatus comprising:
a first movable frame;
a first gripping device mounted to the first frame and adapted to securely hold an optical fiber; and
a second gripping device mounted to the first frame and adapted to securely hold an optical fiber, the first and second gripping devices being spaced apart relative to the first frame and arranged to hold a same optical fiber at different places along a length of the optical fiber, the first and second gripping devices being movable with the first frame to pick, move and place an optical fiber;
wherein the first and second gripping devices are mounted to the first frame so that at least one of the first and second gripping devices is free to move in an axial direction approximately parallel to a longitudinal axis of the optical fiber.

59. The apparatus of claim 58, wherein the first and second gripping devices are resiliently biased apart in the axial direction to tension in optical fiber held by the first and second gripping devices.

60. The apparatus of claim 58, wherein at least one of the first and second gripping devices is rotatable relative to the other of the first and second gripping devices.

61. The apparatus of claim 58, further comprising:
a second frame that is moveable independently of the first frame;
a third gripping device mounted to the second frame and adapted to securely hold an optical fiber;
a fourth gripping device mounted to the second frame and adapted to securely hold and optical fiber, the third and fourth gripping devices being spaced apart relative to the second frame and arranged to simultaneously hold a same optical fiber at different places along a length of the optical fiber; and
the first and second frames being moveable and the gripping devices operable to transfer an optical fiber held by the first and second gripping devices to the third and fourth gripping devices in a handoff operation.

62. The apparatus of claim 61, wherein during a transfer of an optical fiber from the first and second gripping devices to the third and fourth gripping devices, the third gripping device is positioned near the first gripping device and the fourth gripping device is positioned near the second gripping device, the third and fourth gripping devices grasp the optical fiber, and the first and second gripping devices release the optical fiber.

63. The apparatus of claim 61, wherein the first, second, third and fourth gripping devices are interlaceable for transferring an optical fiber between the first and second gripping devices to the third and fourth gripping devices.

64. A manipulation apparatus for handling optical fibers, the apparatus comprising:
a first manipulator comprising:
a first movable frame,
a first gripping device mounted to the first frame and adapted to securely hold an optical fiber, and
a second gripping device mounted to the first frame and adapted to securely hold an optical fiber, the first and second gripping devices being spaced apart relative to the first frame and arranged to hold a same optical fiber at different places along a length of the optical fiber, the first and second gripping devices being movable with the first frame to pick, move and place an optical fiber; and
a second manipulator comprising:
a second frame that is moveable independently of the first frame;
a third gripping device mounted to the second frame and adapted to securely hold an optical fiber;
a fourth gripping device mounted to the second frame and adapted to securely hold an optical fiber, the third and fourth gripping devices being spaced apart relative to the second frame and arranged to hold a same optical fiber at different places along a length of the optical fiber;
wherein the first and second frames are moveable and the gripping devices are operable to transfer an optical fiber held by the first and second gripping devices to the third and fourth gripping devices in a handoff operation.

65. The apparatus of claim 64, wherein the first and second gripping devices are interlaced with the third and fourth gripping devices during handoff of an optical fiber.

66. The apparatus of claim 65, wherein during handoff of an optical fiber from the first and second gripping devices to the third and fourth gripping devices, the third gripping device is positioned near the first gripping device and the fourth gripping device is positioned near the second gripping device, the third and fourth gripping devices grasp the optical fiber, and the first and second gripping devices release the optical fiber.

67. A method for processing at least one optical fiber associated with a work pallet, the at least one optical fiber having a fixed portion fixed to the work pallet and a free end opposite the fixed portion that is movable relative to the work pallet, the method comprising:
picking the free end of at least one optical fiber from the work pallet via a manipulator apparatus;
delivering the free end of the at least one optical fiber to a first optical fiber processing station; and
returning the free end to the work pallet after processing by the first optical fiber processing station is complete.

68. The method of claim 67, wherein the step of picking the free end comprises:
grasping the free end of the at least one optical fiber with gripping devices at two displaced positions along a length of the at least one optical fiber.

69. The method of claim 67, wherein the step of picking the free end comprises:
picking a free end of two optical fibers from the work pallet at a same time.

70. The method of claim 69, further comprising:
joining the free ends of the two optical fibers at the first optical fiber processing station; and
delivering the two joined optical fibers to a second optical fiber processing station without returning the two joined optical fibers to the work pallet.

71. The method of claim 67, further comprising:
picking a free end of at least one other optical fiber from the work pallet;
delivering the free end of the at least one other optical fiber to a second processing station; and
performing at least one process on the free end of the at least one optical fiber at the first optical fiber processing station and at least one process on the free end of the at least one other optical fiber at the second optical fiber processing station approximately simultaneously.

72. The method of claim 67, further comprising:
performing at least one process on the free end of the at least one optical fiber at the first optical fiber processing station; and
delivering the free end of the at least one optical fiber to a second optical fiber processing station without returning the free end of the at least one optical fiber to the work pallet.

73. The method of claim 72, wherein the step of delivering the free end of the at least one optical fiber to a second optical fiber processing station comprises:
transferring the free end of the at least one optical fiber from a first manipulator to a second manipulator.

74. The method of claim 67, further comprising:
moving the work pallet during a time in which the free end of the at least one optical fiber is removed from the work pallet.

75. The method of claim 67, wherein the step of delivering the free end comprises:
delivering the free end to the first optical fiber processing station at a position above the work pallet.

76. A method of handling an optical fiber, comprising:
positioning a first clamping surface including a curved surface near an optical fiber;
positioning a second clamping surface including two planar surfaces arranged at an angle relative to each other near the optical fiber; and
moving the first and second clamping surfaces together to grip the optical fiber between the first and second clamping surfaces.

77. The method of claim 76, further comprising:
using air pressure to define a clamping pressure between the first and second clamping surfaces.

78. The method of claim 76, further comprising:
moving the first and second clamping surfaces apart so that the optical fiber is restrained within an area near the first and second clamping surfaces, but not securely clamped between the first and second clamping surfaces.

79. A method of handling an optical fiber, comprising:
positioning a first clamping surface near an optical fiber;
positioning a second clamping surface near the optical fiber;
moving the first and second clamping surfaces together to grip the optical fiber between the first and second clamping surfaces; and
defining a clamping force exerted on the optical fiber by the clamping surfaces based on an air pressure.

80. The method of claim 79, wherein the step of defining a clamping force comprises:
supplying pressurized air to an actuator that moves the clamping surfaces relative to each other.

81. A method of handling an optical fiber, comprising:
positioning a first surface near an optical fiber;
positioning a second surface near the optical fiber; and
maintaining the first and second surfaces in a relative position so that the optical fiber is restrained within an area near the first and second surfaces, but not securely clamped between the first and second surfaces.

82. A method of handling an optical fiber, comprising:
grasping an optical fiber with at least two gripping devices in a first manipulator arranged to manipulate the optical fiber;
positioning at least two gripping devices in a second manipulator near the optical fiber while the optical fiber is held by the at least two gripping devices in the first manipulator;
grasping the optical fiber with the at least two gripping devices in the second manipulator while the optical fiber is restrained in some manner by the first manipulator; and
releasing the optical fiber from the at least two gripping devices in the first manipulator.
